(19) United States
(12) Patent Application Publication
(10) Pub. No.: US 2012/0030257 A1
(43) Pub. Date: Feb. 2, 2012

(54) SYSTEM AND METHOD OF SCREENING AND INTERVENING WITH INDIVIDUALS TO MODIFY BEHAVIOR

(76) Inventors: Michael Conder, Bainbridge, GA (US); Daniel Guy, Baindbridge, GA (US)

(21) Appl. No.: 12/844,466

(22) Filed: Jul. 27, 2010

(51) Int. Cl. G06F 17/30; G06F 21/22; G06F 3/14

(52) U.S. Cl. 707/812; 715/234; 726/18; 707/E17.009

(57) ABSTRACT

The present invention is a computer program product for modifying the behavior of an individual. The computer program product is a computer usable medium having a computer readable code embodied thereon. A first graphical user interface on a web server has a first template to be completed by a individual. The first template collects a first set of information regarding a particular behavior of the first individual. The computer program product analyzes the first set of information collected on a first database and compares the first set of information to a matrix which cross references the first set of information to a particular behavior. Computer program product then assigns a series of modules to the individual. The series of modules consists of steps which the individual must complete. The steps consist of an introduction video, vocabulary questions, a lecture, role play videos, peer to peer video, a post lecture, a shout back lab (opportunity for the individual to answer free form questions) and a quiz. The individual's answers to the quiz are stored as a second set of information in the first database. The second set of information can be reviewed by the administrator and reports can be compiled for the particular individual at issue or for multiple individuals.

### CROSS-REFERENCES TO RELATED APPLICATIONS

Not Applicable STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of computer software behavioral systems. More specifically, the present invention comprises a computer software product that executes a method and system for training, teaching and intervening in an unwanted behavior pattern.

2. Description of the Related Art

Various systems and methods exist for training and teaching behavioral modification. Additionally, intervening in problematic behavior has been the topic of psychology and sociology for hundreds of years.

Oftentimes, educational institutions, churches or other similar organizations develop systems of intervening with behavior of adolescents. These systems typically involve sitting down with an advisor or a counselor and discussing problems or concerns of the adolescent. However, adolescents can be embarrassed or uncomfortable discussing their problems with an adult, even a young adult. They may feel that they are unable to relate or that they will get into trouble for revealing something that they shouldn't have done. Without having all of the information and motivation for an adolescent's behavior it is difficult to determine why a problem occurred and prevent it from occurring again.

Additionally, there are time constraints which prevent organizations from spending the amount of time with each individual and to compile all of an individual's file or a particular sub-groups file to see trends and potential answers to why or what was causing the individual or group's behavior.

Therefore, what is needed is a system and method of screening and intervening with individuals to modify their behavior which allows individuals to interact comfortably with others, to track and monitor information gathered in the interaction, to compile the information in an organized manner to view trends or patterns and to provide feedback to the individual in order to modify the undesirable behavior.

### BRIEF SUMMARY OF THE INVENTION

The present invention is a computer program product for modifying the behavior of an individual. The computer program product is comprised of a computer usable medium having a computer readable code embodied thereon. A first graphical user interface displays a first template to be completed by a first individual. The first template collects a first set of information regarding a particular behavioral offense of the individual. The computer program product analyzes the first set of information collected on a database and compares the first set of information to a matrix which cross references the first set of information to a particular behavior. Computer program product then assigns a module sequence to the individual. The module sequence consists of steps which the individual must complete. The steps consist of an introduction video, vocabulary questions, a lecture, role play videos, peer to peer video, a post lecture, a shout back lab (opportunity for the individual to answer free form questions) and a quiz. The individual's answers to the quiz are stored as a second set of information in the first database. The information collected can be reviewed by the administrator and reports can be compiled for the particular individual at issue or for multiple individuals.

### BRIEF DESCRIPTION OF THE SEVERAL VIEWS OF THE DRAWINGS

FIG. 1 is a block diagram showing the manner in which the present invention is accessed.

FIG. 2 is a block diagram showing the servers and access device which the present invention is stored and executed on.

FIG. 3 illustrates a sample of the contents of the disciplinary offense database.

FIG. 4 illustrates a flow diagram of the present invention as accessed by an individual.

FIG. 5 illustrates a flow diagram of the present invention as accessed by an administrator.

FIG. 6 illustrates a screen shot showing the login screen of the present invention.

FIG. 7 illustrates a screen shot showing the dashboard of the present invention.

FIG. 8 illustrates a screen shot showing the questions session of the present invention.

FIG. 9 illustrates a screen shot showing the screen after the questions are completed in the present invention.

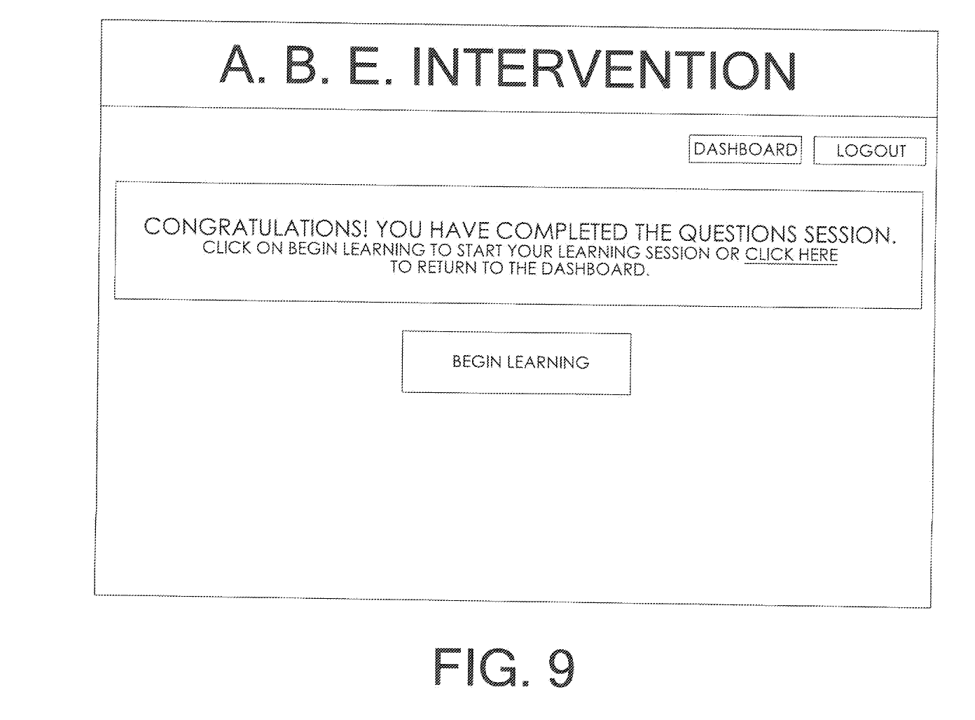

FIG. 10 illustrates a screen shot showing the introduction of the present invention.

FIG. 11 illustrates a screen shot showing the vocabulary session of the present invention.

FIG. 12 illustrates a screen shot showing the vocabulary session of the present invention.

FIG. 13 illustrates a screen shot showing the vocabulary session of the present invention.

FIG. 14 illustrates a screen shot showing the lecture of the present invention.

FIG. 15 illustrates a screen shot showing the role play video of the present invention.

FIG. 16 illustrates a screen shot showing the role play video of the present invention.

FIG. 17 illustrates a screen shot showing the role play video of the present invention.

FIG. 18 illustrates a screen shot showing the peer to peer video of the present invention.

FIG. 19 illustrates a screen shot showing the peer to peer video of the present invention.

FIG. 20 illustrates a screen shot showing the peer to peer video of the present invention.

FIG. 21 illustrates a screen shot showing the post lecture video of the present invention.

FIG. 22 illustrates a screen shot showing the shout back lab of the present invention.

FIG. 23 illustrates a screen shot showing the quiz session of the present invention.

FIG. 24 illustrates a screen shot showing the quiz session of the present invention.

FIG. 25 illustrates a screen shot showing the completion of the quiz session of the present invention.

FIG. 26 illustrates a screen shot showing the completion of the learning session or module of the present invention.

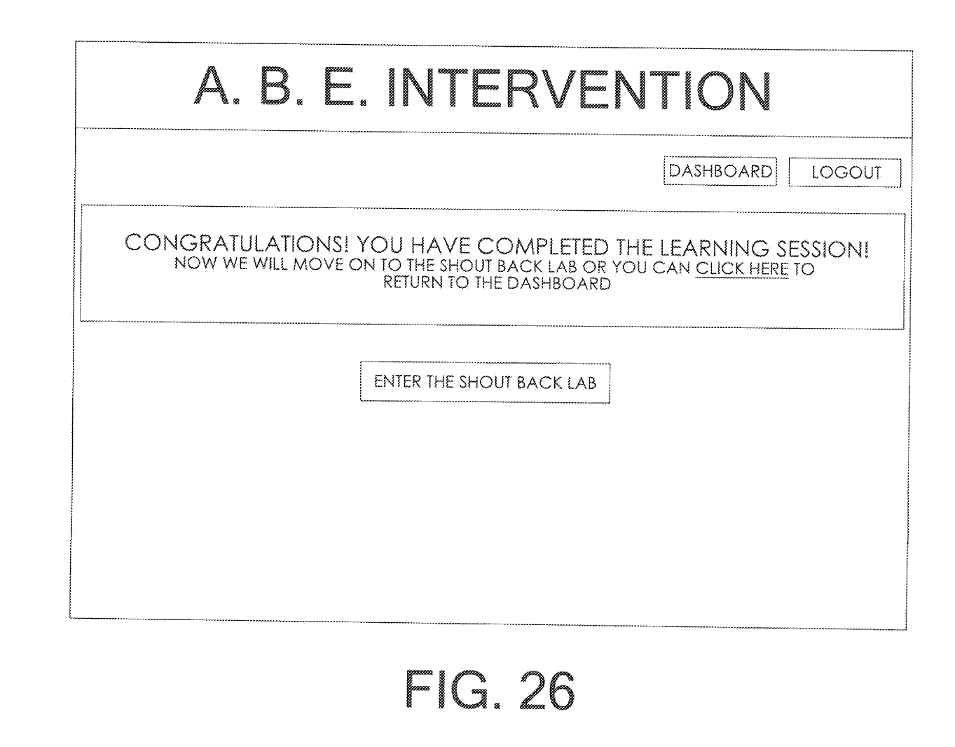

FIG. 27 illustrates a screen shot showing the manage staff section of the present invention.

FIG. 28 illustrates a screen shot showing the manage students section of the present invention.

FIG. 29 illustrates a screen shot showing the reports section of the present invention.

FIG. 30 illustrates a screen shot showing the administrator student profile section of the present invention.

FIG. 31 illustrates a screen shot showing the individual's shout back lab responses of the present invention.

REFERENCE NUMERALS IN THE DRAWINGS

| | | | |
|---|---|---|---|
| 10 | computer program product | 12 | file server |
| 14 | access device | 16 | database server |
| 18 | disciplinary offense database | 20 | first individual |
| 22 | central processing unit (CPU) | 24 | module sequence assignment |
| 26 | computer readable program code | 28 | RAM |
| 30 | first graphic user interface | 32 | template |
| 34 | first set of information | 36 | first module |
| 38 | dashboard | 40 | module sequence |
| 42 | administrator | 44 | introduction |
| 46 | vocabulary | 48 | lecture |
| 50 | role plays | 52 | peer to peer |
| 54 | post lecture | 56 | shout back |
| 58 | quiz | 60 | log-in |
| 62 | second database | 64 | peer |
| 66 | database server | 68 | disciplinary offense database |
| 70 | manage students | 72 | manage staff |
| 74 | reports | 76 | first database |
| 78 | behavioral offense | 80 | pre-test |
| 82 | behavioral assessment test | | |

### DETAILED DESCRIPTION OF INVENTION

The present invention is a computer program product 10 to implement a method and system of modifying the behavior of an individual. The method requires a first individual 20, preferably an individual in need of behavior modification, to access computer program product 10, as described herein.

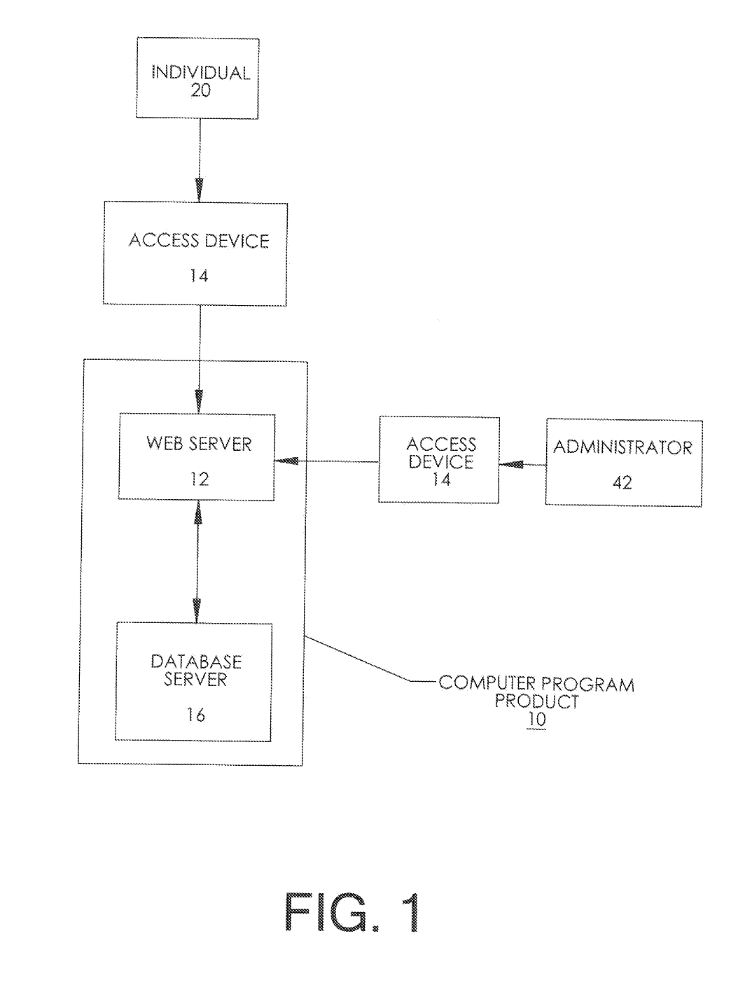

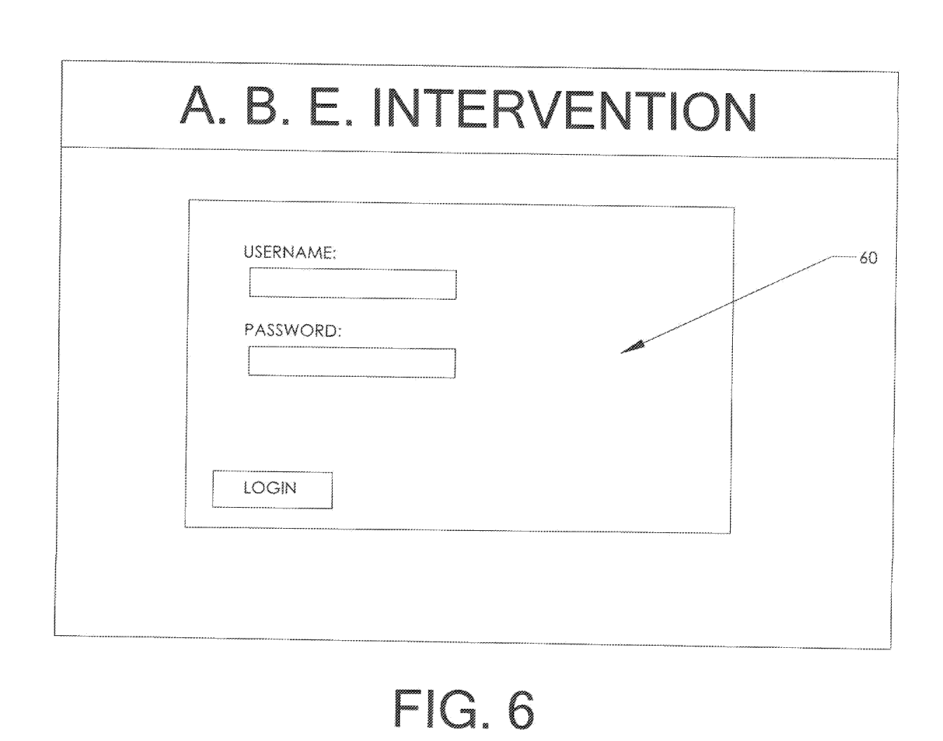

FIG. 1 illustrates the preferred embodiment of the present system in which individual 20 and administrator 42 access computer program product 10. Computer program product 10 and relevant databases are preferably stored on a web server 12 and database server 16 respectively. Individual 20 and Administrator 42 utilize an access device 14 which can be any device which can access the Internet (i.e. a computer, personal digital assistant, etc). Individual 20 and Administrator 42 reach a log-in screen, as shown in FIG. 6, through which individual 20 can log-in to the present computer program product 10.

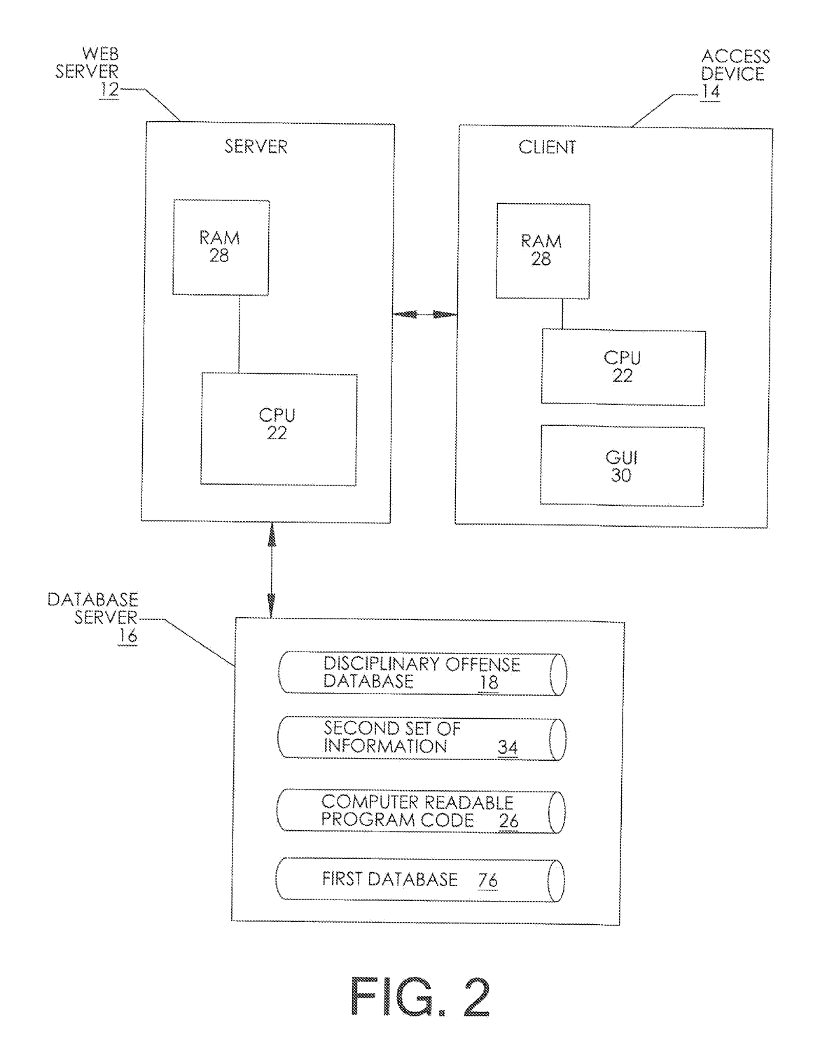

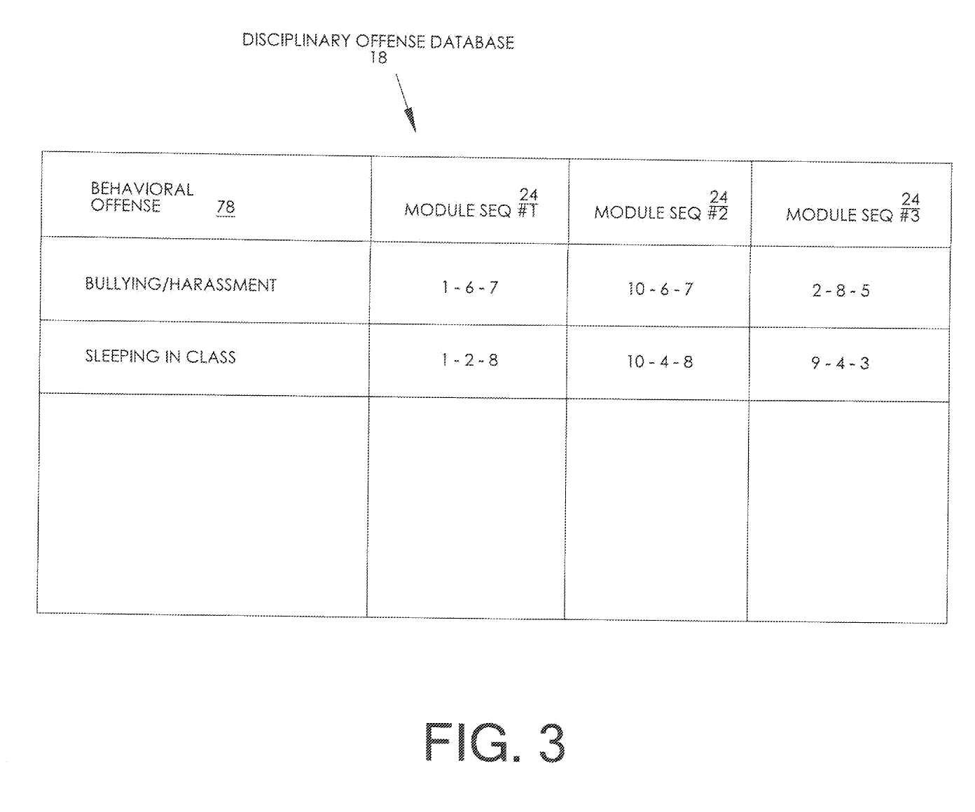

As shown in FIG. 2, when Individual 20 signs in, Individual 20 is directed to a first graphical user interface 30. First graphical user interface 30, located on access device 14, interacts with computer program product 10 located on server 12. Database server 16 holds disciplinary offense database 68, second set of information 34 and computer readable program code 26. Database server 16, server 12 and access device 14 interact to allow either Individual 20 or Administrator 42 to utilize computer program product 10. Database server 16 preferably holds disciplinary offense database 18 illustrated in FIG. 3, second set of information 34 and computer readable code 26. As shown in FIG. 3 disciplinary offense database 18 matches a particular offense with a sequence of module assignments. When computer program product 10 identifies the offending behavior, a module sequence can be assigned which best targets the particular behavioral offense.

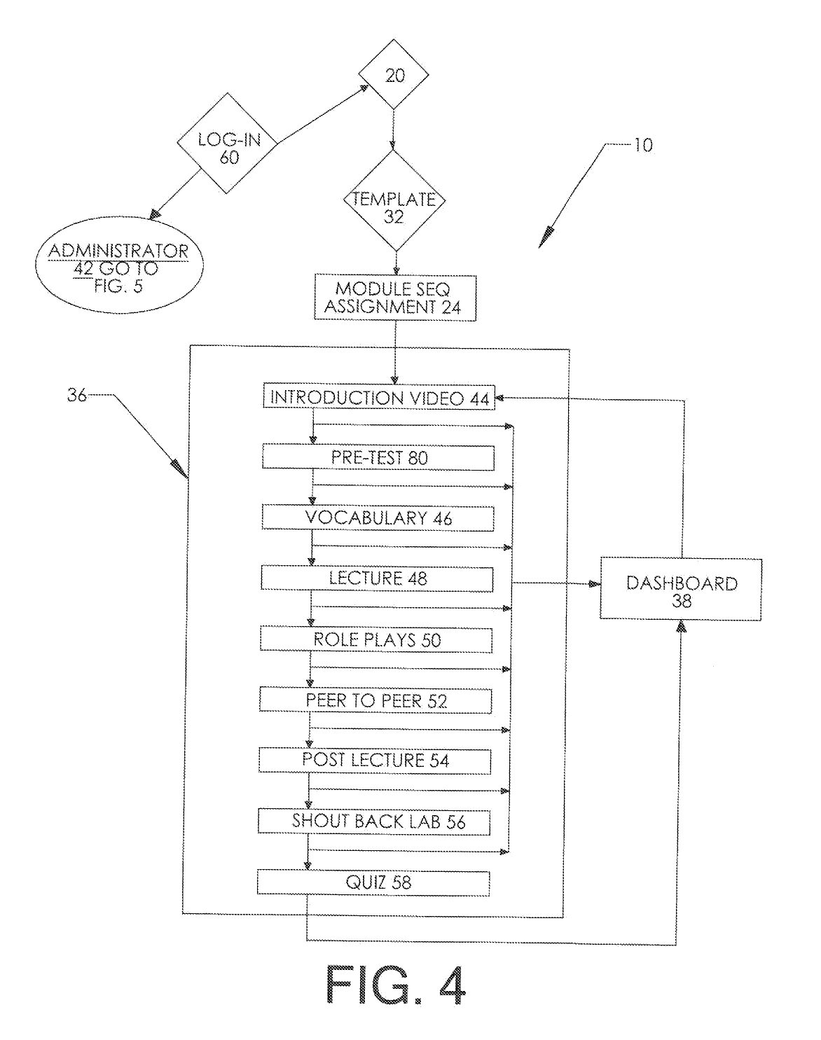

As shown in FIG. 4, when the web address which corresponds to the location of the computer program product 10 is entered the user is brought to a login screen 60, also illustrated in FIG. 6. When individual 20 logs in at login 60 as an individual 20, computer program product 10 brings individual 20 to the sequence for individual 20 (or student). Individual 20 initially accesses a template 32 which includes a series of questions to complete on template 32. Computer program product 10 collects information using a graphical user interface 30 and corresponding template 32 such as the one illustrated in FIG. 2. Graphical user interface 30 preferably includes selectable icons and check boxes. These specific types of input mechanisms are representatives of the types of mechanisms that may be used to capture the information, but are in no way exhaustive of the possibilities.

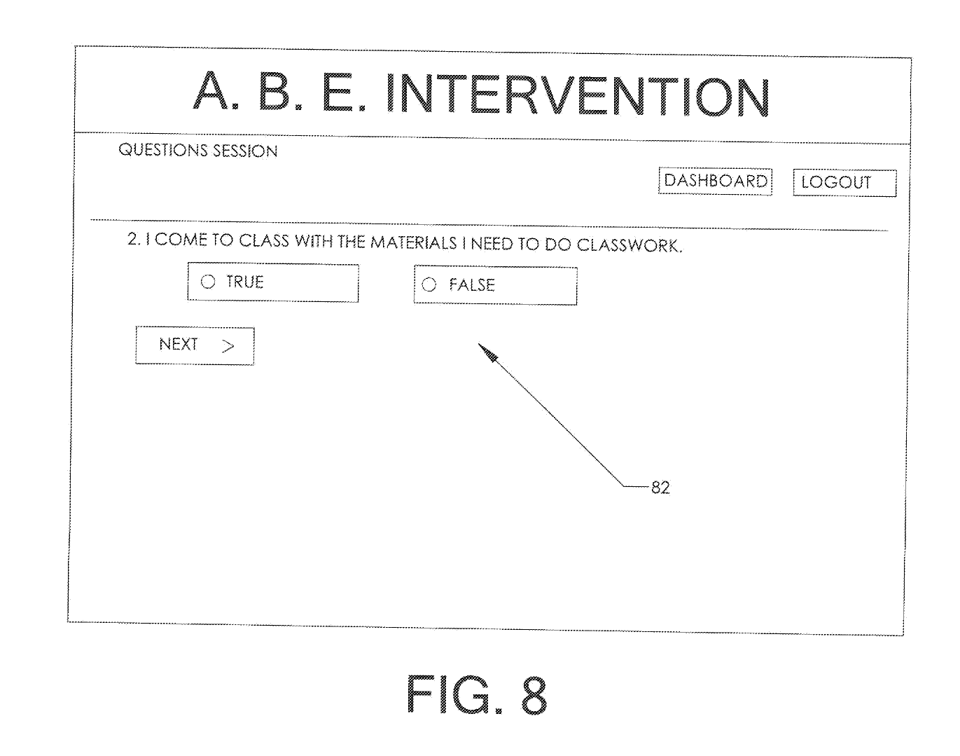

Computer program product 10 collects information regarding the behavior or habits of individual 20. As shown in FIG. 8, individual 20 can choose TRUE or FALSE and click NEXT to move to the next question. As shown in FIG. 2 information collected for individual 20, or first set of information 34, is stored in a first database 76 on database server 16. Returning to FIG. 4, computer program product 10 analyzes first set of information 34 (compiled from behavioral assessment test 82) and assigns behavioral offense 78 to individual 20.

Based on behavioral offense 78, as shown in FIG. 3, the appropriate module sequence 24 is assigned to individual 20. The assignment of a particular module sequence 24 to individual 20 is based on a pre-determined series of modules which administrator 42 believes will best address the behavioral offense 78 which needs modified. In some instances administrator 42 may desire to override the assignment of the modules by computer program product 10. In this case, prior to individual 20 accessing computer program product 10, administrator 42 can set the desired module sequence 24 such that however individual 20 answers the initial questions in template 32, individual 20 will be brought to the module sequence 24 set by administrator 42.

In addition to assigning module sequence 24 first set of information 34 is weighted and scored to determine if individual 20 scores within a normal limit or possible area of concern. If individual 20 scores within a possible area of concern, administrator 42 is notified and proper intervention can occur. Several questions are also flagged for immediate referral if answered in a certain way by individual 20. If notification is required by a particular answer on a flagged question, the program generates a notification e-mail to administrator 42.

Upon beginning the module sequence 24 individual 20 is directed to begin first module 36. As shown in FIG. 4, it is preferable, that each module of module sequence 24 follows the same steps: (1) Introduction 44; (2) Pre-test 80; (3) Vocabulary 46; (4) Lecture 48; (5) Role Plays 50; (6) Peer to Peer 52; (7) Post Lecture 54; (8) Shout Back 56; and (9) Interactive Quiz 58. While these steps are preferable, the steps can be somewhat modified and still achieve the same behavior modification.

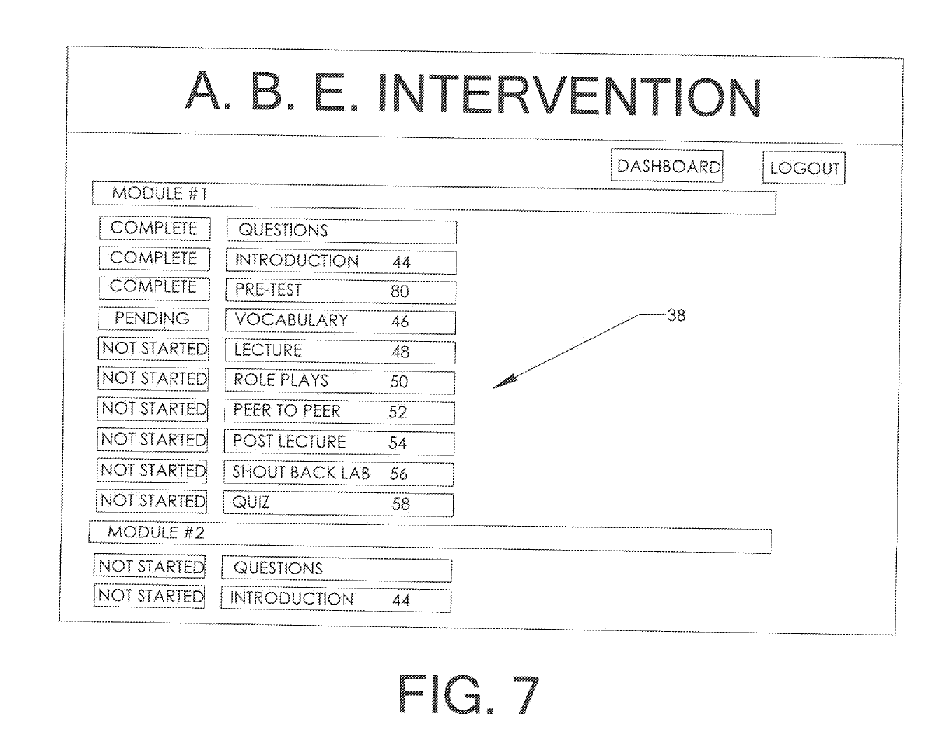

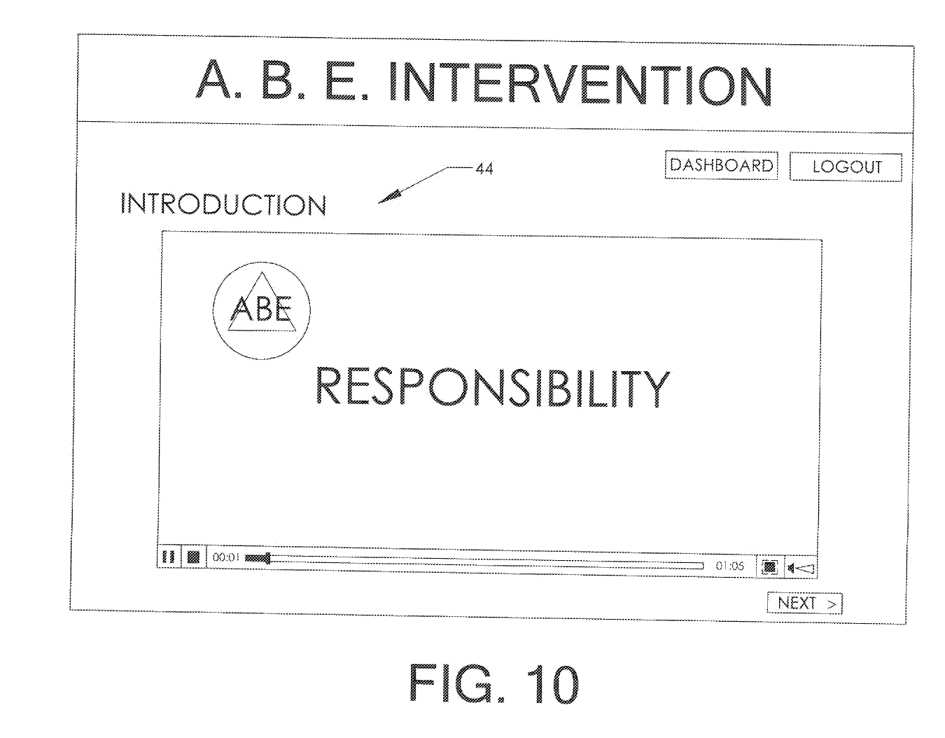

In the first step of the module sequence 24, introduction 44, the individual 20 hears and watches a short video discussing the particular behavioral offense 78 which first module 36 focuses on. An illustrative screen shot of introduction 44 is shown in FIG. 10. Upon completion of introduction 44 individual 20 clicks on the NEXT icon in order to move to the next step in the module sequence 24. Additionally, individual 20 can at any time in module sequence 40 access dashboard 38, shown in FIG. 7. Dashboard 38 is a screen which provides individual 20 with a list of each assigned module, with each step in module sequence 24 listed below the module number. Individual cannot jump ahead in module sequence 24 however, this screen does allow individual 20 to view their status in module sequence 24

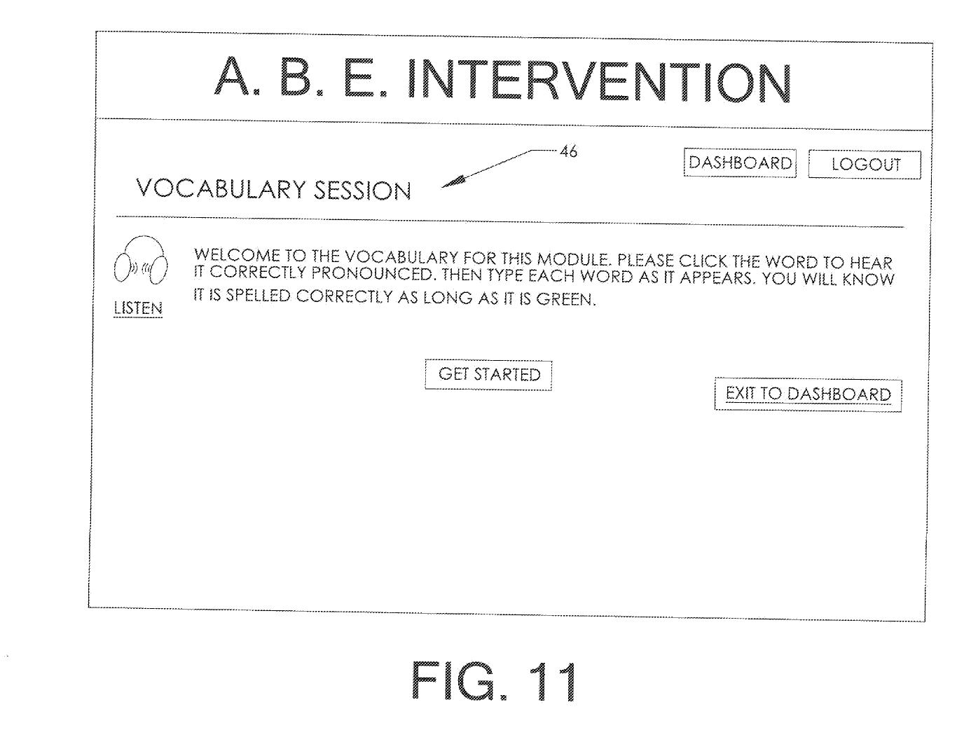

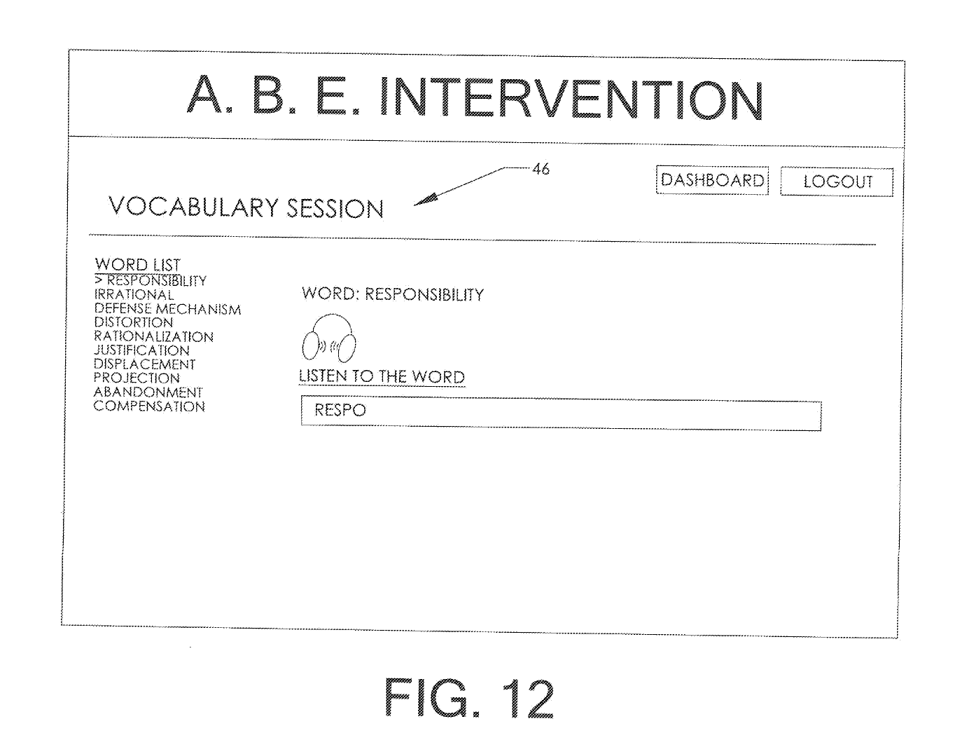

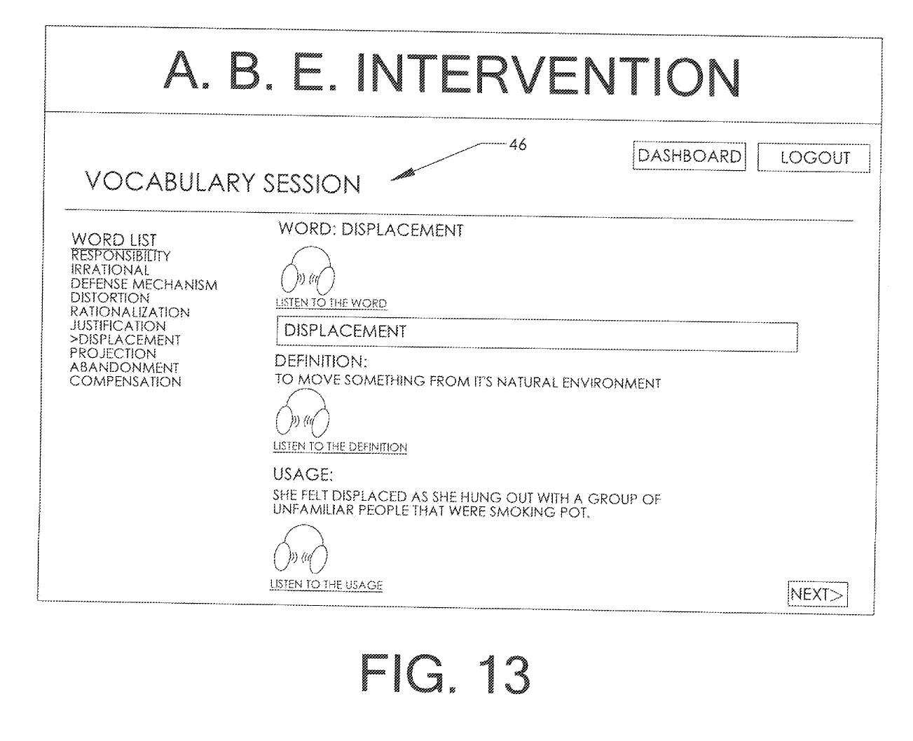

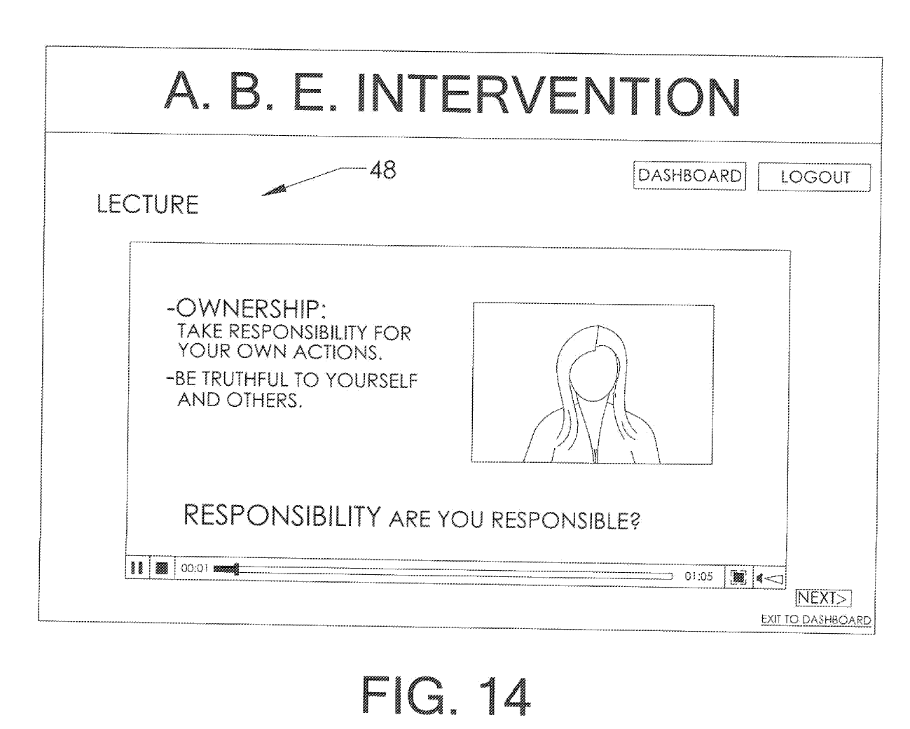

Returning to FIG. 4, pre-test 80 is the second step in the module 36. Pre-test 80 asks the individual 20 a series of questions which permits the administrator 42 to evaluate how much knowledge the individual 20 begins the sequence with. Vocabulary 46 is the third step in module sequence 24. An illustrative screen shot of vocabulary 46 is shown in FIGS. 11, 12 and 13. Individual 20 is given a short description of vocabulary 46 section, as shown in FIG. 11. Moving to FIG. 12, a vocabulary word is listed for the individual 20 to listen to pronunciation and type with assistance. Only when individual 20 accurately types vocabulary word and listens to the pronunciation can individual 20 move to listening to the definition and the usage of the word, as illustrated in FIG. 13. Each series of words is presented in connection with a specific module sequence 24. Individual 20 cannot move to the next word until individual 20 types the word, listens to the meaning and listens to the usage of the word. Only when this is complete can individual 20 click on the NEXT icon to bring up the next word in the series. After individual 20 completes all vocabulary words, lecture 48 begins, as shown in FIG. 4. Lecture 48 plays a video and audio of an adult discussing the particular behavioral focus of the relevant module, as illustrated in FIG. 14.

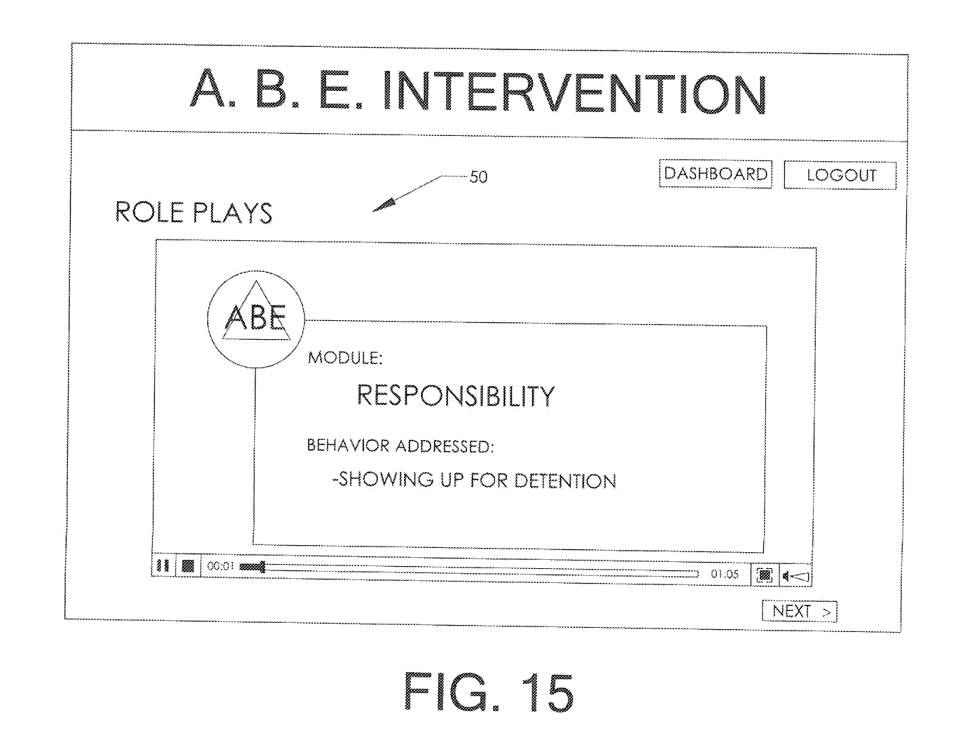

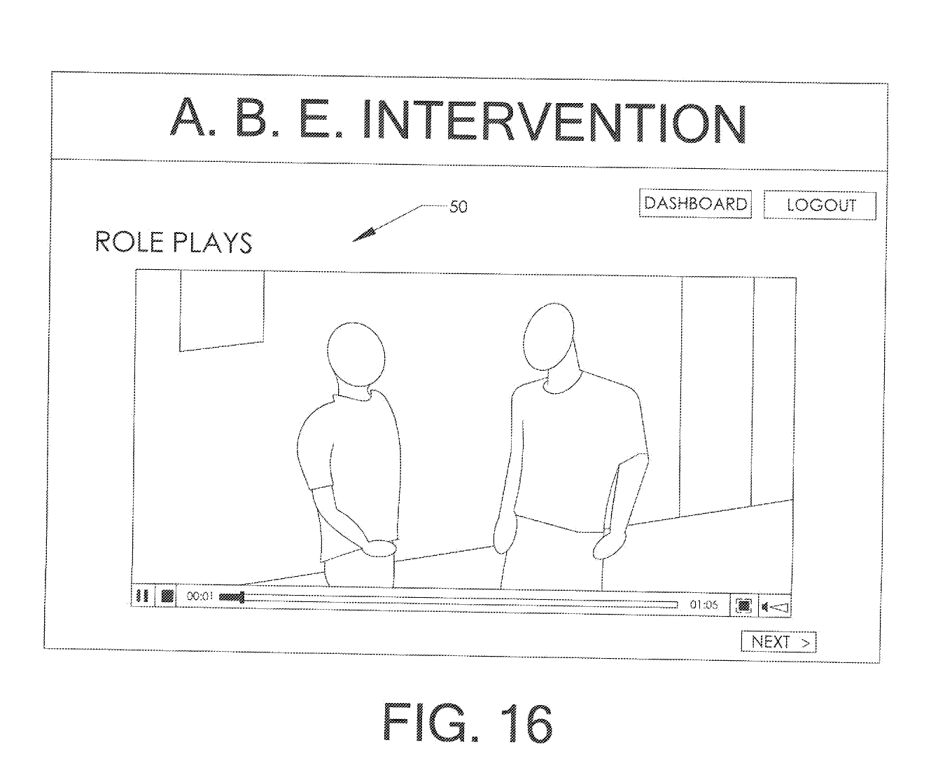

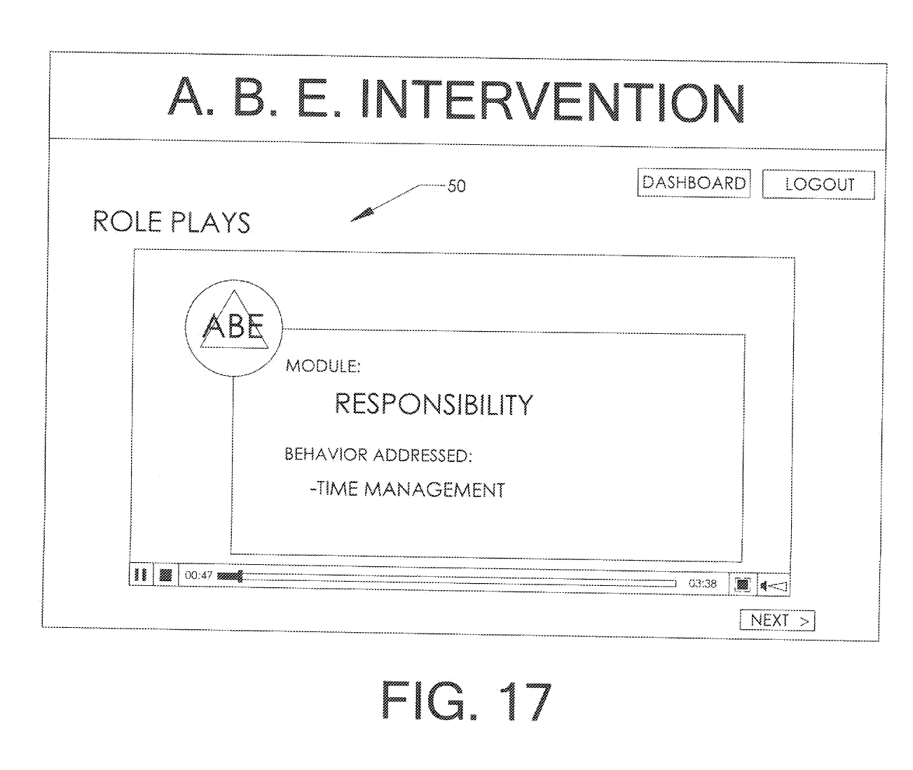

Next, individual 20 enters role play 50 step, illustrated in FIGS. 15, 16, and 17, where a video plays for individual 20 showing other individuals interacting in specific scenarios representative of situations in which the relevant adverse behavior may be displayed. For example, if the behavior module 24 is focused on cheating, role play 50 may involve several identical scenarios in which individuals are tempted to look at a classmate's answers to a homework assignment or test and where, in different scenarios, the individuals react differently to achieve different results. Role play 50 focuses on actual scenarios which individual 20 can identify how to improve their ability to choose the correct behavior within a particular role and how that correct behavior will impact their day to day activities in a positive way.

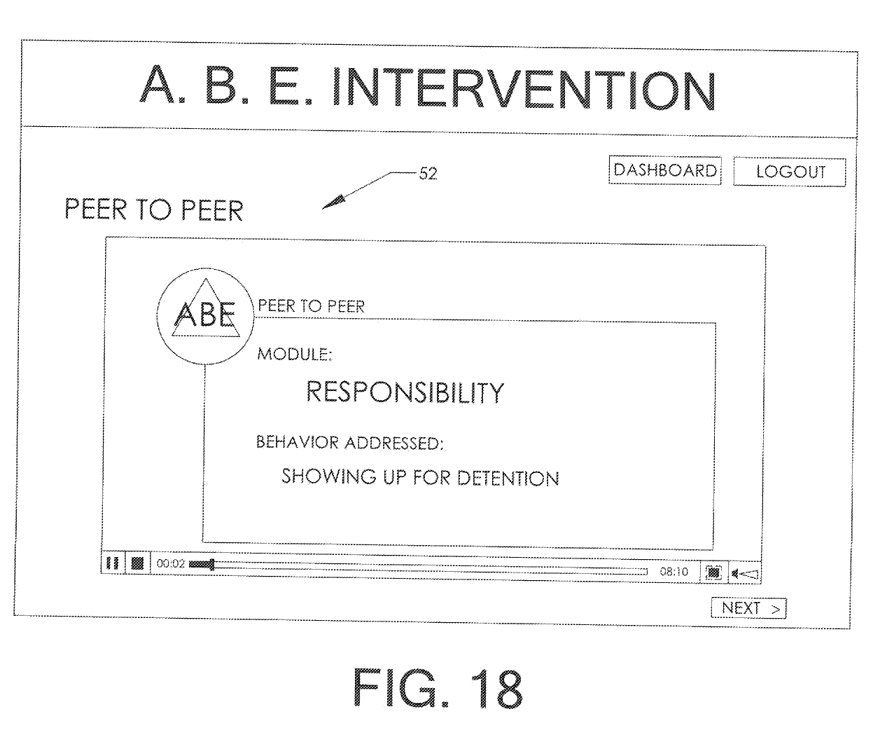

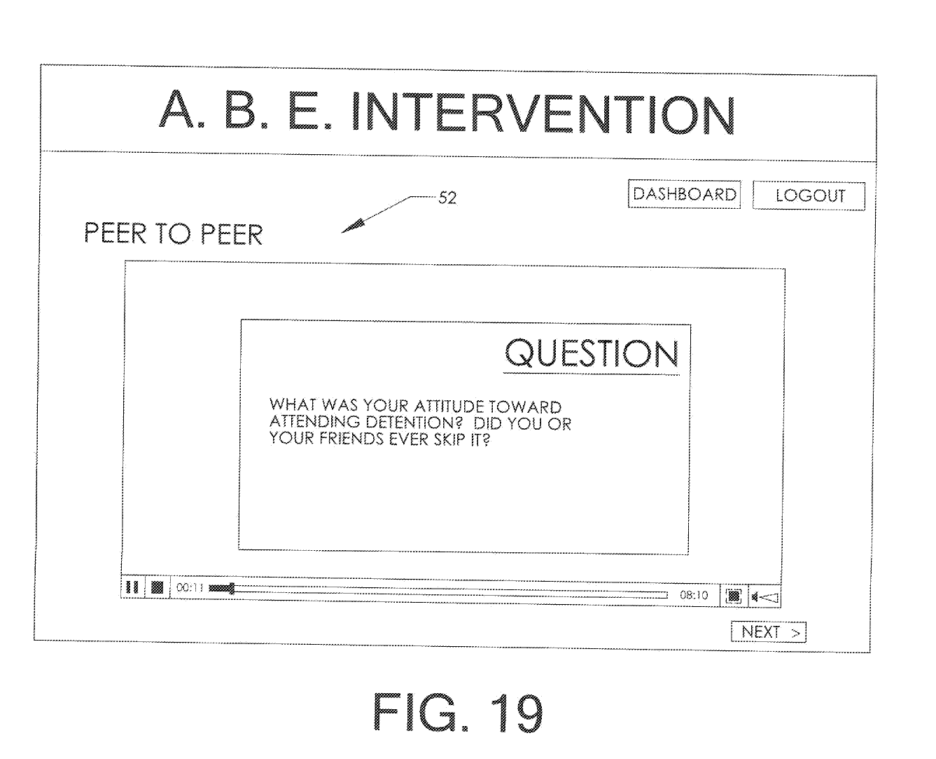

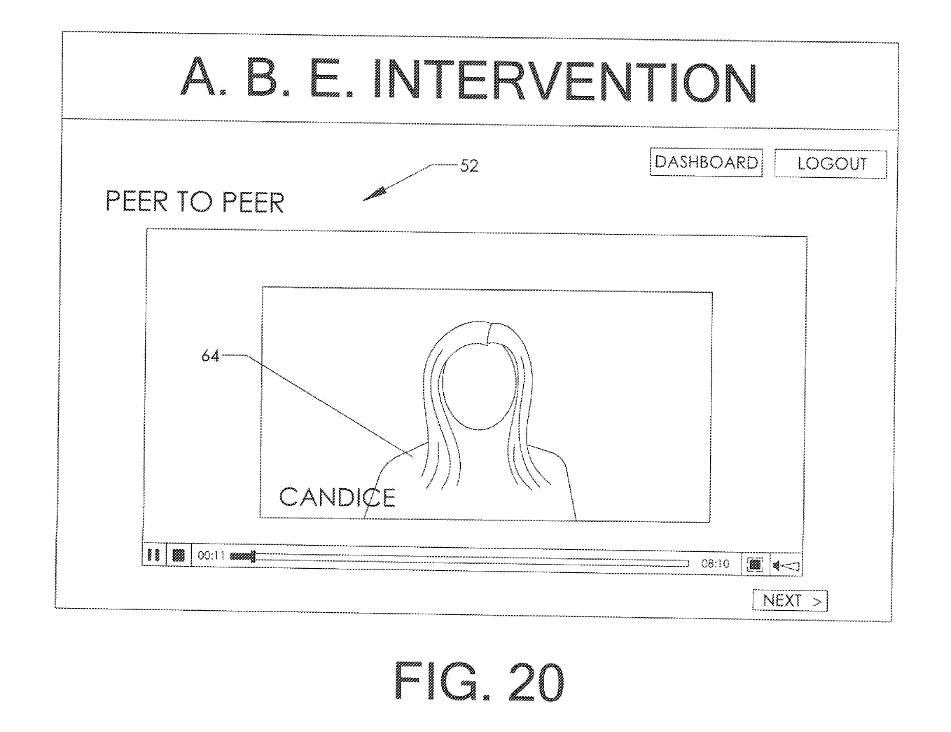

Individual 20 then moves to step 6, Peer to Peer 52, shown in FIGS. 18, 19 and 20. Peer to Peer 52 gives individual 20 the opportunity to watch and listen to a peer 64 or young adult/adolescent who discusses their experience with the particular behavioral offense 78 and what changed when they began to make better choices and eliminate the negative behavior. Each peer 64 answers a series of questions relevant to the particular behavior module. The questions are presented on the screen before each peer 64 answers it.

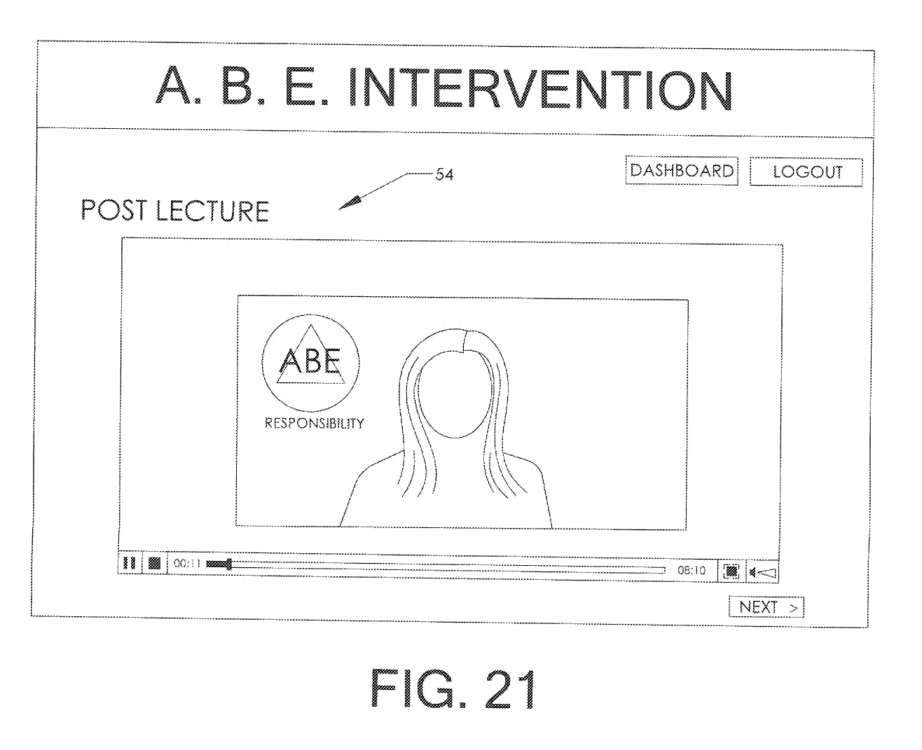

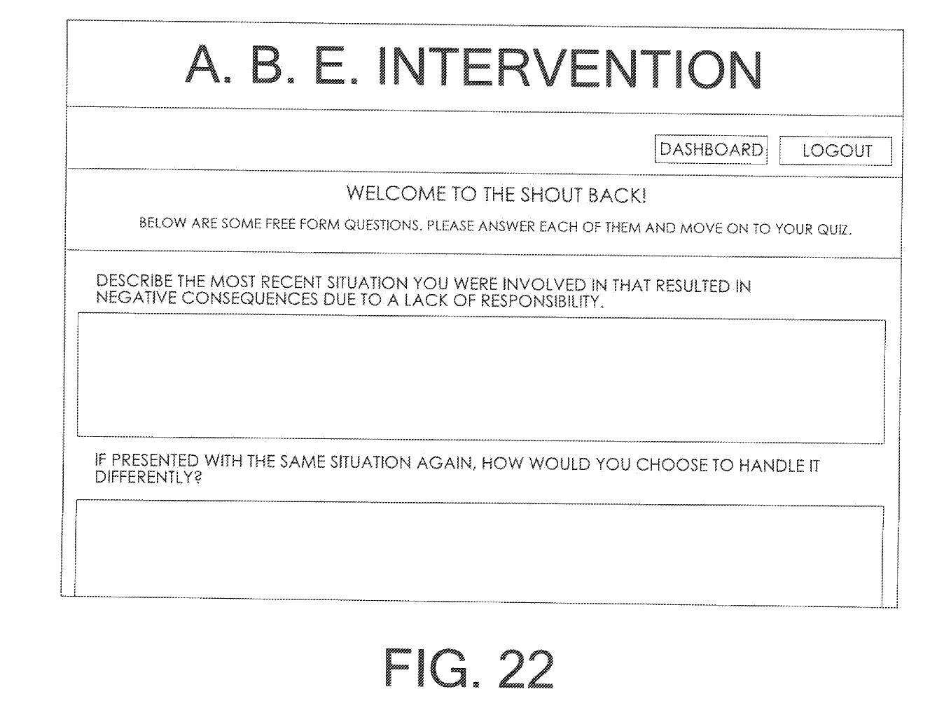

Step 7, Post Lecture 54 brings individual 20 back to a video of an adult discussing what was learned throughout the module and what individual 20 should be able to accomplish by utilizing the techniques described in the module sequence 24, as shown in FIG. 21. Next, individual 20 is invited to give feedback in the “Shout Back Lab” 56, illustrated in FIG. 22. Shout Back Lab 56 focuses on the situations which individual 20 has been involved in regarding the behavioral offense 78 and how individual 56 hopes to change that behavior. Individual 20 is also asked to indicate whether they would like to talk with a counselor and is invited to make any other comments.

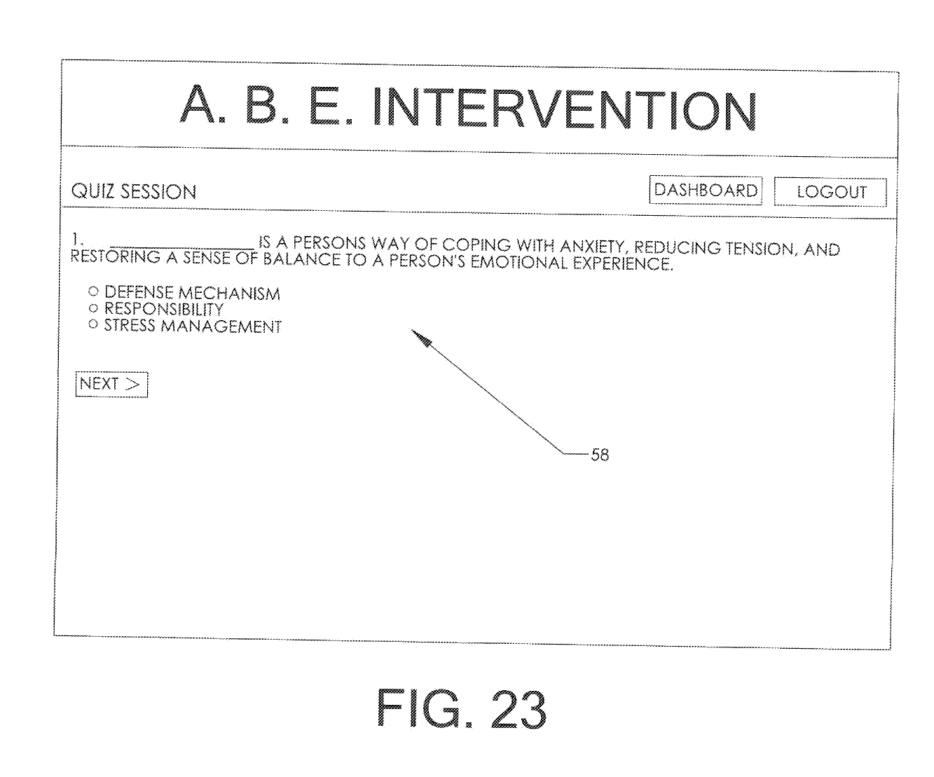

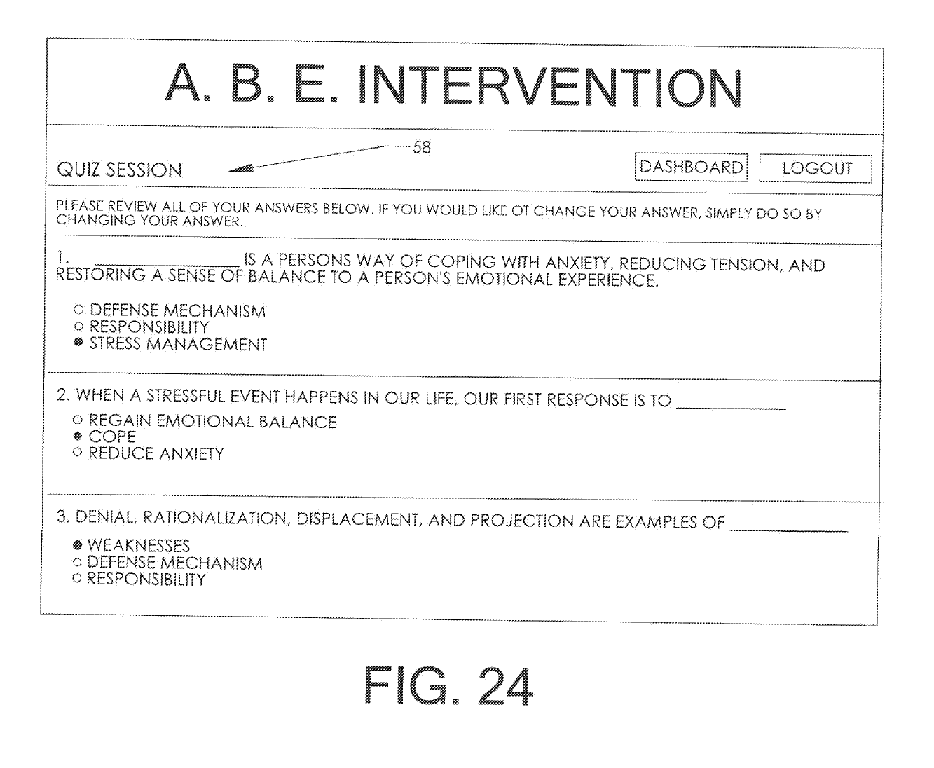

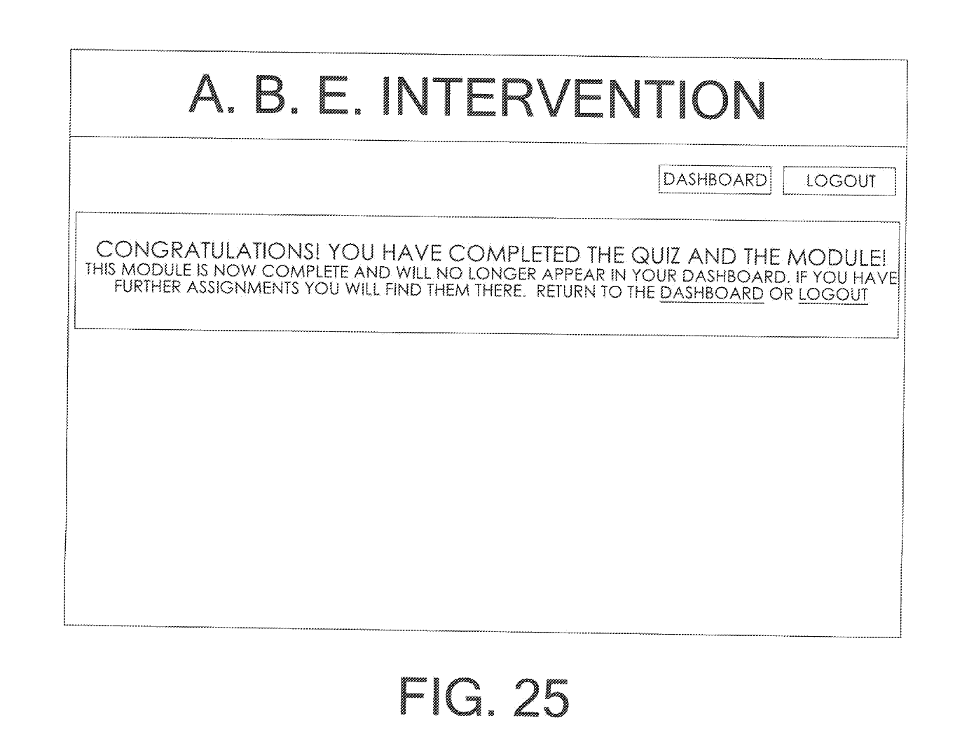

Finally, as shown in FIG. 23, individual 20 is given a Quiz 58, which tests the individual on the substance of the particular module 36. Quiz 58 consists of a series of multiple choice and true and false questions. Individual 20 has the opportunity to review the answers before submitting them, as shown in FIG. 24. Upon submitting the answers individual 20 can either return to dashboard or log out, as shown in FIG. 25. If individual 20 chooses to return to dashboard 38, the completed modules will no longer appear. Individual 20 can then begin the next module 36.

Returning to FIG. 2, when submitted by individual 20, answers to Quiz 58, second set of information 34, will be stored in database server 16 for later review by administrator 42 as described herein.

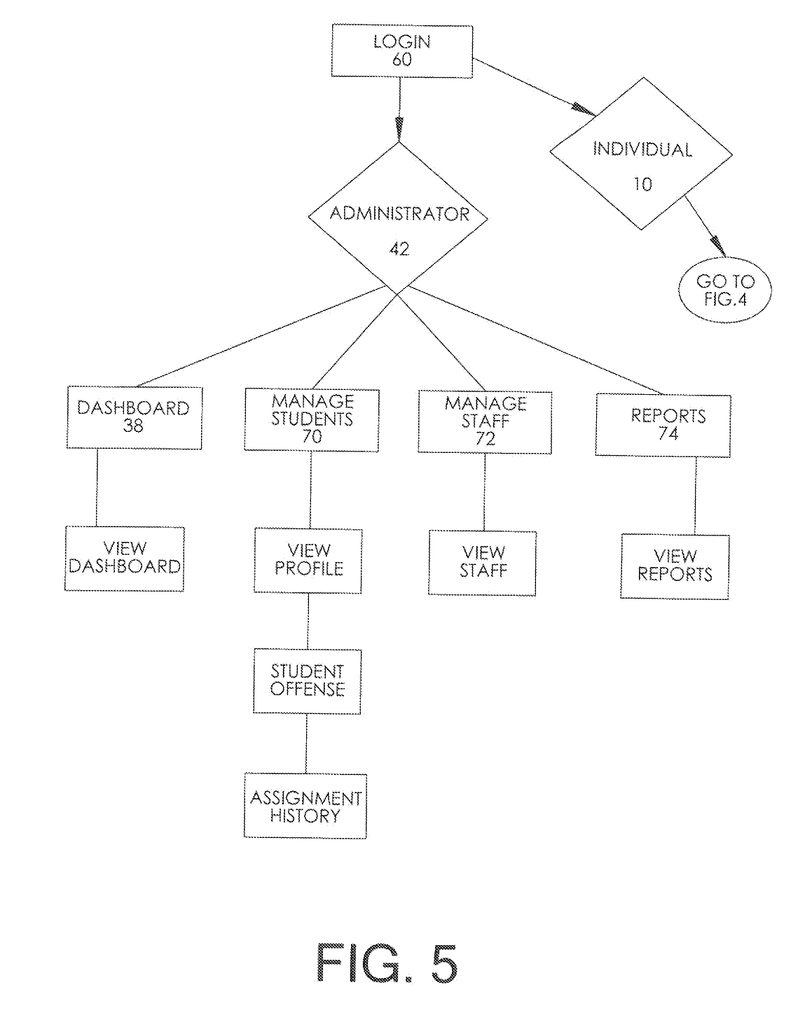

When the administrator 42 chooses to access to computer program product 10 administrator 42 also enters the web address which corresponds to the location of the computer program product 10. Administrator 42 is brought to the same login screen 60, illustrated in FIG. 6. When administrator 42 logs in at login 60 screen as an administrator 42, computer program product 10 brings administrator 42 to the administrator 42 sequence shown in FIG. 5.

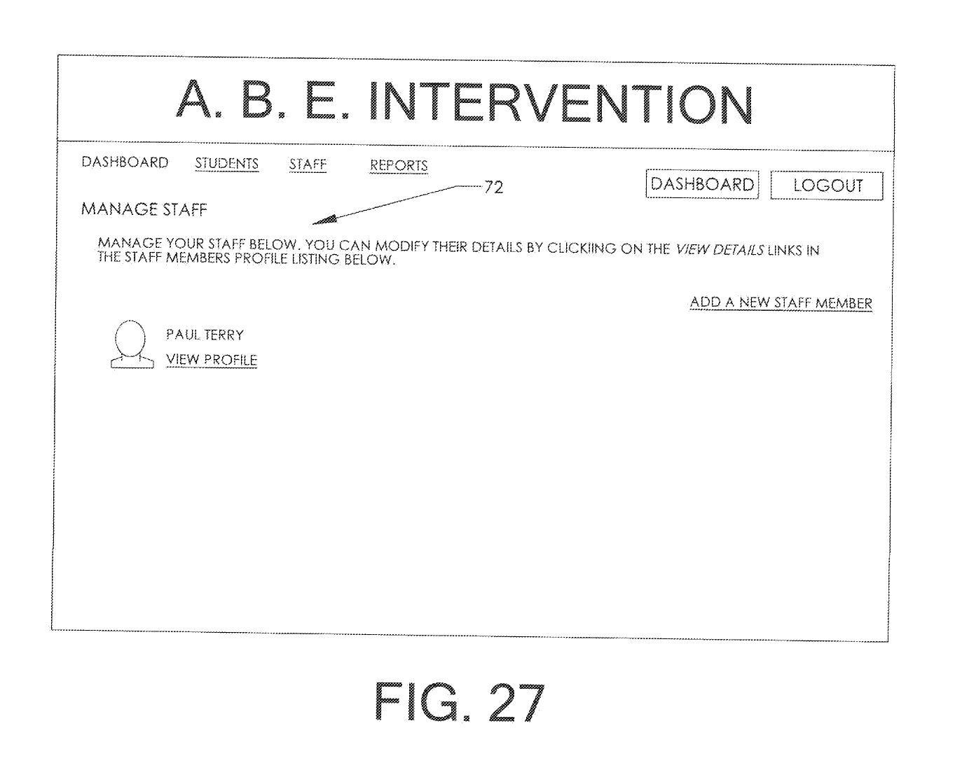

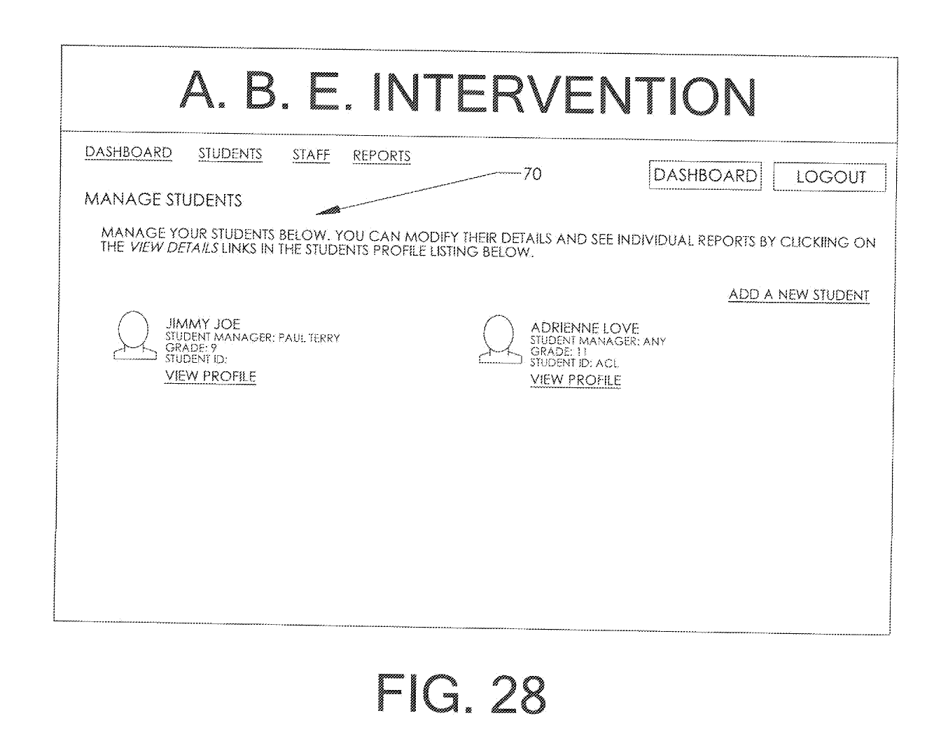

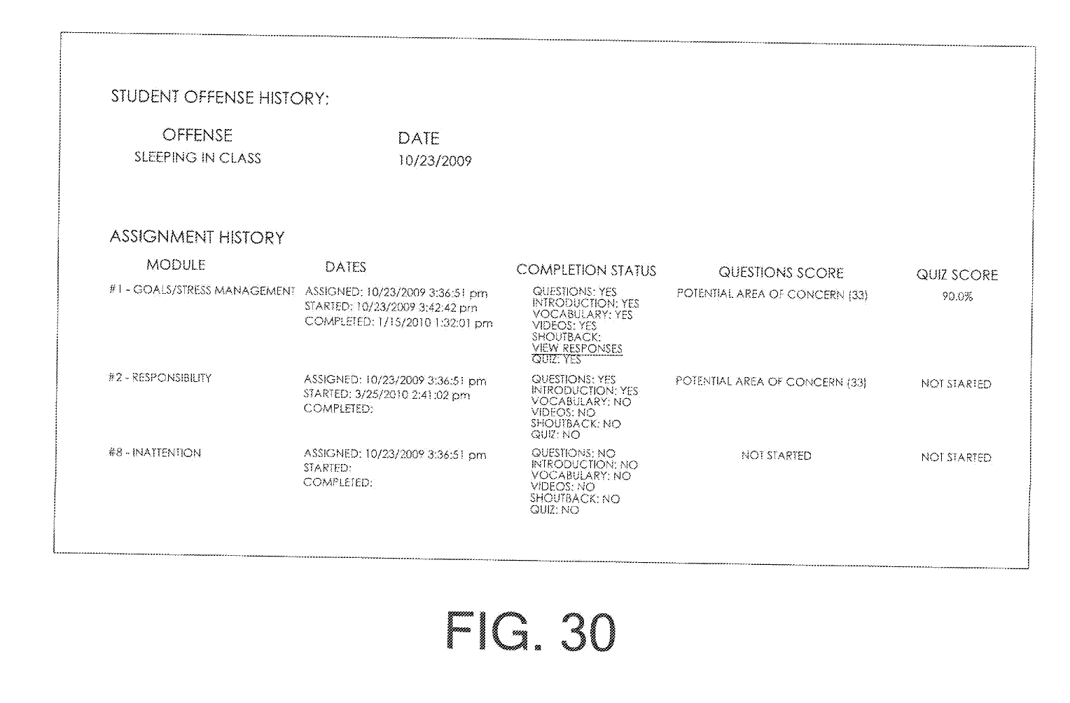

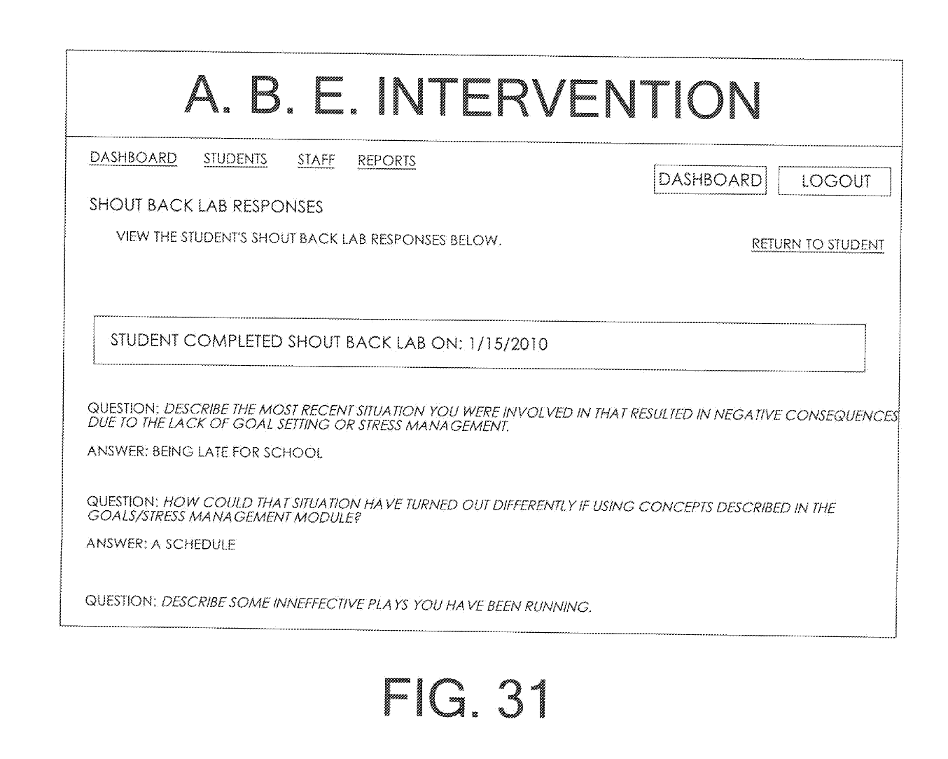

Administrator 42 can access dashboard 38, manage students section 70, manage staff section 72 and reports 74. Administrator 42 can access profile of individual 20 in manage students section 70, as illustrated in FIGS. 28, 30 and 31, which includes a student profile comprised of a student identifier, student offense history and assignment history. Student identifier can be any way of identifying student, in the preferred embodiment student identifier is a student ID and grade level indicator. Student offense history lists the offense and the date of the offense (further information can include time of offense, course in which offense occurred, etc). Assignment history lists the modules assigned, the date them module was assigned, started and completed, the completion status, questions score and quiz score. Additionally, assignment history has links which allow administrator to view shout back lab responses. Administrator 42 can access manage staff section 72 which allows administrator 42 to view their own profile or create additional staff users, as shown in FIG. 27. Additionally, certain results, such as whether the student passed or failed are electronically mailed to administrator 42 for immediate review and student mentoring.

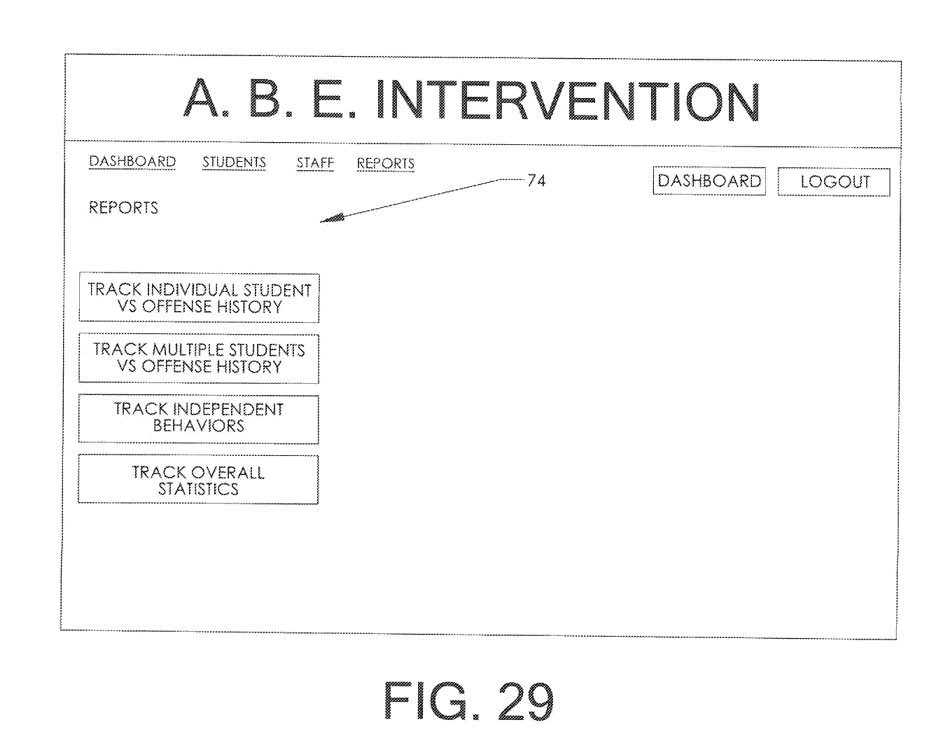

Administrator 42 can also access reports 74, illustrated in FIG. 29, where data is compiled for administrator 42 to review. Reports 74 allow administrator 42 not only to view results of each individual but also allows administrator 42 to view trends of a series of individual. Reports 74 can be generated which: (1) tracks one students behavior related to his or her student offense history or identifying information (e.g. time of day, particular class, type of behavior, how often it occurs, etc.); (2) tracks a series of individuals behavior in relation to where the event occurred to potentially determine detailed problem areas (e.g. a particular course, time of day, age group, etc.); (3) tracks the independent behaviors themselves (e.g. types of behaviors that are occurring, specific times the behaviors are occurring, etc.); and (4) tracks overall statistics related to race, age, grade, gender and educational division (e.g. special ed, general ed or self-contained).

The preceding description contains significant detail regarding the novel aspects of the present invention. It should not be construed, however, as limiting the scope of the invention but rather as providing illustrations of the preferred embodiments of the invention. As an example, the steps of each module 36 can be somewhat modified. In addition, computer program product 10 may be stored and executed on an individual computer and/or the data may be stored on a data storage device other than a database server. Thus, the scope of the invention should be fixed by the following claims, rather than by the examples given.

1. A computer program product, comprising a computer usable medium having a computer readable program code embodied therein, said computer readable program code adapted to be executed to implement a method of modifying the behavior of a first individual comprising:
a. a graphical user interface on a web server having a first template to be completed by said first individual;
b. collecting a first set of information regarding a particular behavior of said first individual;
c. a first database stored on said computer usable medium containing said first set of information;
i. wherein said computer program product analyzes said first set of information and compares said first set of information to an offense database;
ii. wherein said offense database assigns said individual to a first module based on said first set of information;
ii. wherein said computer program product directs said individual to said first module;
d. wherein said first individual completes said first module;
e. wherein a second set of information is collected from said first individual after the completion of said first module; and
f. wherein said computer program product generates a report.

2. The computer program product of claim 1, wherein said first module further comprises:
a. a database stored on said computer usable medium associated with said first module containing a first series of questions regarding a first topic;
b. presenting said individual with said first series of questions regarding said first topic;
c. presenting a training program regarding said specific topic;
d. providing a second template comprised of a series of test questions for said first individual to complete regarding said specific topic;
e. recording a second set of information collected by said database in response to said second template; and
f. creating a report regarding said second set of information collected from said first individual.

3. The computer program product of claim 1, further comprising:
a. an access device wherein said individual can access and interact with said computer program product through said access device;
b. a database stored on said computer usable medium containing a plurality of individual data;
c. wherein said individual is assigned a username and a password; and
d. wherein said individual must input said username and said password in order to access said computer program product.

4. The computer program product of claim 1, further comprising:
a. a second module; and
b. a third module.

5. The computer program product of claim 4, wherein said second module further comprises:
a. a database stored on said computer usable medium associated with said second module containing a second series of questions regarding a second topic;
b. presenting said individual with said second series of questions regarding said second topic;
c. presenting a training program regarding said second topic;
d. providing a third template comprised of a series of test questions for said first individual to complete regarding said second topic;
e. recording a third set of information collected by said database in response to said third template; and
f. creating a report regarding said third set of information collected from said first individual.

6. The computer program product of claim 1, wherein an administrator can access said computer program product through an access device.

7. The computer program product of claim 6, wherein said administrator can access said first database having said first set of information, said second set of information and said report.

8. The computer program product of claim 7, wherein:
a. said computer program product monitors said first set of information for a possible area of concern; and
b. if said possible area of concern is detected said computer program product generates a notification to said administrator.

9. The computer program product of claim 1, wherein:
a. said first individual has a history of offenses; and
b. wherein said computer program product can compile a report which tracks said first set of information for said first individual compared to said history of offenses of said first individual.

10. The computer program product of claim 1, wherein:
a. a plurality of sets of information are collected for a plurality of individuals;
b. said plurality of sets of information are stored on said first database; and
c. said computer program product can compile said plurality of sets of information having said history of offenses into a plurality of reports.

11. The computer program product of claim 10, wherein said plurality of reports includes a report comparing a plurality of independent behaviors.

12. The computer program product of claim 10, wherein said plurality of reports includes a report tracking overall statistics of said plurality of individuals.

13. A computer program product, comprising a computer usable medium having a computer readable program code embodied therein, said computer readable program code adapted to be executed to implement a method of modifying the behavior of a plurality of individuals, and wherein an administrator can access and modify information entered by said plurality of individuals, comprising:
a. a first graphical user interface on a web server having a first template to be completed by said plurality of individuals;
b. a second graphical user interface on a web server having a second template to be completed by said administrator;
c. wherein said computer program product collects a plurality of first sets of information from said first and second templates regarding a particular behavior of said plurality of individuals;
d. a first database stored on said computer usable medium containing said plurality of first sets of information;
i. wherein said plurality of first sets of information determines a behavioral offense;
ii. wherein said computer program product analyzes said plurality of first sets of information and compares said plurality of first sets of information to an offense database;
iii. said offense database matches said behavior offense with a particular module sequence including a first module, a second module and a third module;
e. wherein said computer program product directs said plurality of individuals to said first module;
f. wherein said plurality of individuals completes said first module;
g. wherein a third set of information is collected from said plurality of individuals at the completion of said first module;
h. wherein said computer program product directs said plurality of individuals to said second module;
i. wherein said plurality of individuals completes said second module;
j. wherein a fourth set of information is collected from said plurality of individuals at the completion of said second module;
k. wherein said computer program product directs said plurality of individuals to said third module;
l. wherein said plurality of individuals completes said third module;
m. wherein a third set of information is collected from said plurality of individuals at the completion of said third module; and
n. wherein said computer program product generates a report which can be accessed by said administrator.

14. The computer program product of claim 13, wherein said first module, second module and third module further comprises:
a. a database stored on said computer usable medium associated with said first module having:
i. an introduction video regarding a first topic;
ii. a series of questions regarding said first topic which allows said plurality of individuals can input a series of answers;
iii. a vocabulary training session regarding said first topic;
iv. a lecture video regarding said first topic;
v. a role playing video regarding said first topic;
vi. a peer to peer video regarding said first topic;
vii. a post lecture video regarding said first topic;
viii. a third template allowing said plurality of individuals to input a series of answers;
ix. a fourth template comprised of a series of test questions for said plurality of individuals to complete regarding said first topic;
b. recording a plurality of sets of information collected by said database in response to said second template; and
c. creating a report regarding said plurality of sets of information collected from said plurality of individuals.

15. The computer program product of claim 13, further comprising:
a. an access device wherein said plurality of individuals can access and interact with said computer program product through said access device;
b. a database stored on said computer usable medium containing a plurality of individual data;
c. wherein said plurality of individuals are assigned a username and a password; and
d. wherein said plurality of individuals must input said username and said password in order to access said computer program product.

16. The computer program product of claim 13, wherein an administrator can access said computer program product through an access device.

17. The computer program product of claim 13, wherein:
a. said computer program product monitors said first set of information for a possible area of concern; and
b. if said possible area of concern is detected said computer program product generates a notification to said administrator.

18. The computer program product of claim 13, wherein:
a. a plurality of sets of information are collected for said plurality of individuals;
b. said plurality of sets of information are stored on said first database; and
c. said computer program product can compile said plurality of sets of information having said history of offenses into a plurality of reports.

19. The computer program product of claim 18, wherein said plurality of reports includes a report comparing a plurality of independent behaviors.

20. The computer program product of claim 18, wherein said plurality of reports includes a report tracking overall statistics of said plurality of individuals.
